(19) United States
(12) Patent Application Publication
(10) Pub. No.: US 2026/0339336 A1
(43) Pub. Date: Oct. 29, 2026

(54) ROUTE-SETTING METHOD, PROGRAM, AND MOVING BODY

(71) Applicant: MITSUBISHI HEAVY INDUSTRIES, LTD., Tokyo (JP)

(72) Inventors: Satoshi Kato, Tokyo (JP); Kazushige Takaki, Tokyo (JP); Satoshi Iio, Tokyo (JP); Yasuo Fujishima, Tokyo (JP); Kenji Takao, Tokyo (JP)

(73) Assignee: MITSUBISHI HEAVY INDUSTRIES, LTD., Tokyo (JP)

(21) Appl. No.: 19/110,892

(22) PCT Filed: Sep. 12, 2023
(86) PCT No.: PCT/JP2023/033129

§ 371 Date: Mar. 12, 2025

(30) Foreign Application Priority Data
Sep. 15, 2022 (JP) 2022-147194

(51) Int. Cl. G05D 1/622; B66F 9/06; B66F 9/075; G05D 1/644; G05D 105/20; G05D 107/70; G05D 109/10; G05D 111/10

(52) U.S. Cl. CPC G05D 1/622; B66F 9/063; B66F 9/0755; G05D 1/644; G05D 2105/20; G05D 2107/70; G05D 2109/10; G05D 2111/17

(57) ABSTRACT

A route-setting method includes: a step of setting a first reference route to a movement destination; a step of acquiring a detection result of an obstacle detected by a sensor provided in a moving body, while the moving body is moving along the first reference route; a step of setting a sub-goal, which is a position assumed not to interfere with the obstacle, based on the detection result of the obstacle; a step of setting a second reference route passing through a position within a prescribed distance range with respect to the sub-goal; and a step of setting an avoidance route for the moving body that does not interfere with the obstacle, based on the second reference route and on the detection result of the obstacle.

### TECHNICAL FIELD

The present disclosure relates to a route-setting method, a program, and a moving body.

### BACKGROUND ART

A moving body that automatically moves is known. For example, PTL 1 discloses detecting an obstacle and generating a local map including a traversable region in which a moving body can travel and an obstacle region in which the obstacle is positioned.

### Citation List

### Patent Literature

[PTL 1] Japanese Unexamined Patent Application Publication No. 2014-164424

### SUMMARY OF INVENTION

### Technical Problem

Here, it may take time to set a route that can avoid the obstacle. Therefore, it is required to set a route that can appropriately avoid the obstacle while reducing computation time.

The present disclosure is made to solve the above-described problem, and an object of the present disclosure is to provide a route-setting method, a program, and a moving body which enable setting a route that can appropriately avoid an obstacle while reducing computation time.

### Solution to Problem

A route-setting method according to the present disclosure includes a step of acquiring a detection result of an obstacle detected by a sensor provided in a moving body, a step of setting a sub-goal, which is a position assumed not to interfere with the obstacle, based on the detection result of the obstacle, a step of setting a reference route passing through a position within a prescribed distance range with respect to the sub-goal, and a step of setting an avoidance route for the moving body that does not interfere with the obstacle, based on the reference route and on the detection result of the obstacle.

A program according to the present disclosure causes a computer to execute a step of acquiring a detection result of an obstacle detected by a sensor provided in a moving body, a step of setting a sub-goal, which is a position assumed not to interfere with the obstacle, based on the detection result of the obstacle, a step of setting a reference route passing through a position within a prescribed distance range with respect to the sub-goal, and a step of setting an avoidance route for the moving body that does not interfere with the obstacle, based on the reference route and on the detection result of the obstacle.

A moving body according to the present disclosure is a moving body that moves along an avoidance route set not to interfere with an obstacle, in which the avoidance route is set based on a reference route passing through a position within a prescribed distance range with respect to a sub-goal and on a detection result of the obstacle detected by a sensor provided in the moving body, and the sub-goal is set as a position assumed not to interfere with the obstacle based on the detection result of the obstacle.

### Advantageous Effects of Invention

According to the present disclosure, it is possible to set a route that can appropriately avoid an obstacle while reducing computation time.

### BRIEF DESCRIPTION OF DRAWINGS

FIG. 1 is a schematic diagram of a movement control system according to the present embodiment.

FIG. 2 is a schematic diagram of a configuration of a moving body.

FIG. 3 is a schematic block diagram of a management device.

FIG. 4 is a schematic block diagram of an information processing device.

FIG. 5 is a schematic block diagram of a control device of the moving body.

FIG. 6 is a schematic diagram showing an example of a setting method of a sub-goal.

FIG. 7 is a schematic diagram showing an example of the setting method of a sub-goal.

FIG. 8 is a schematic diagram showing an example of the setting method of a sub-goal.

FIG. 9 is a schematic diagram showing an example of setting a reference route.

FIG. 10 is a schematic diagram showing an example of setting an avoidance route.

FIG. 11 is a flowchart showing a processing flow for setting the avoidance route.

FIG. 12 is a schematic diagram for showing setting of a non-interference region.

FIG. 13 is a schematic diagram for showing the setting of the non-interference region.

FIG. 14 is a schematic diagram for showing another example of the setting of the non-interference region.

FIG. 15 is a schematic diagram showing an example of an extraction method of analysis point groups.

FIG. 16 is a schematic diagram showing setting of an occupied region.

### DESCRIPTION OF EMBODIMENTS

Hereinafter, a preferred embodiment of the present disclosure will be described in detail with reference to the accompanying drawings. The present disclosure is not limited to the embodiment. In addition, in a case where there are a plurality of embodiments, the present disclosure also includes configurations obtained by combining each embodiment.

### First Embodiment

### Movement Control System

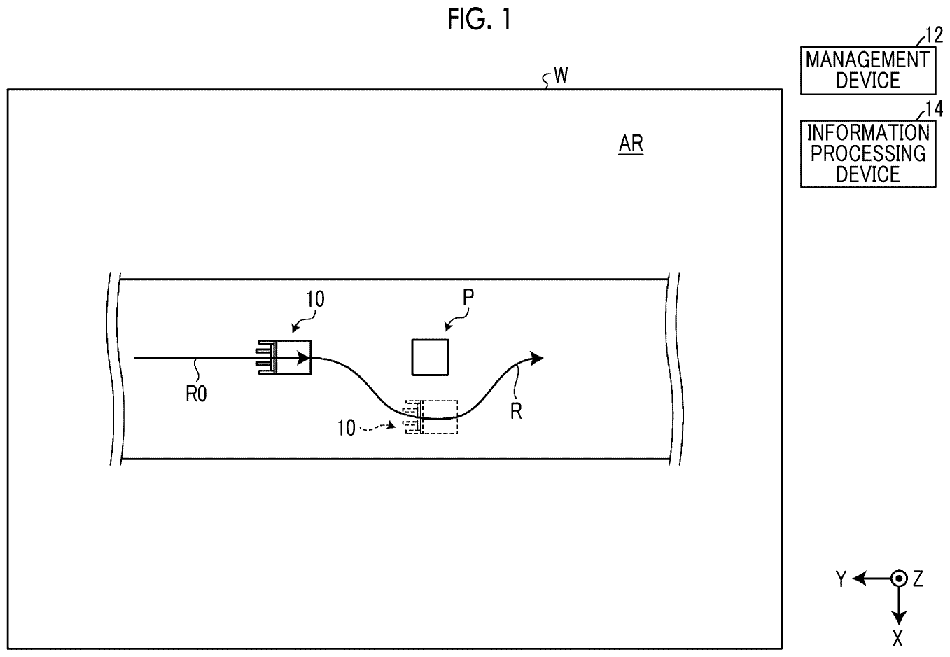

FIG. 1 is a schematic diagram of a movement control system according to the present embodiment. As shown in FIG. 1, a movement control system 1 according to the present embodiment includes a moving body 10, a management device 12, and an information processing device 14. The movement control system 1 is a system that controls a movement of the moving body 10 belonging to a facility W. The facility W is, for example, a facility that is involved in physical distribution management, such as a warehouse, but may be any facility that operates the moving body 10. In the movement control system 1, the moving body 10 picks up and transports a target object disposed in a region AR of the facility W. The region AR is, for example, a floor surface of the facility W and is a region where the target object is installed or the moving body 10 moves. The target object transported by the moving body 10 is an object to be transported on which cargo is loaded on a pallet in the present embodiment. However, the target object is not limited to a target object on which the cargo is loaded on the pallet, and may be in any form. For example, a target object Q may be only the cargo without the pallet. In addition, the moving body 10 is not limited to a moving body that transports the target object, and may be a device that moves in the facility W for any purpose.

Hereinafter, one direction along the region AR is referred to as an X direction, and a direction along the region AR and crossing the X direction is referred to as a Y direction. In the present embodiment, the Y direction is a direction orthogonal to the X direction. The X direction and the Y direction may be referred to as directions along a horizontal plane. In addition, a direction orthogonal to the X direction and the Y direction, more specifically, a direction toward an upper side in a vertical direction, is referred to as a Z direction. In addition, in the present embodiment, a “position” refers to a position (coordinates) in a coordinate system (coordinate system of the region AR) on a two-dimensional plane in the region AR, unless otherwise specified. In addition, a “posture” of the moving body 10 or the like is, unless otherwise specified, a direction of the moving body 10 or the like in the coordinate system of the region AR, and indicates a yaw angle (rotation angle) of the moving body 10 when the X direction is set to 0° when viewed from the Z direction.

### Moving Body

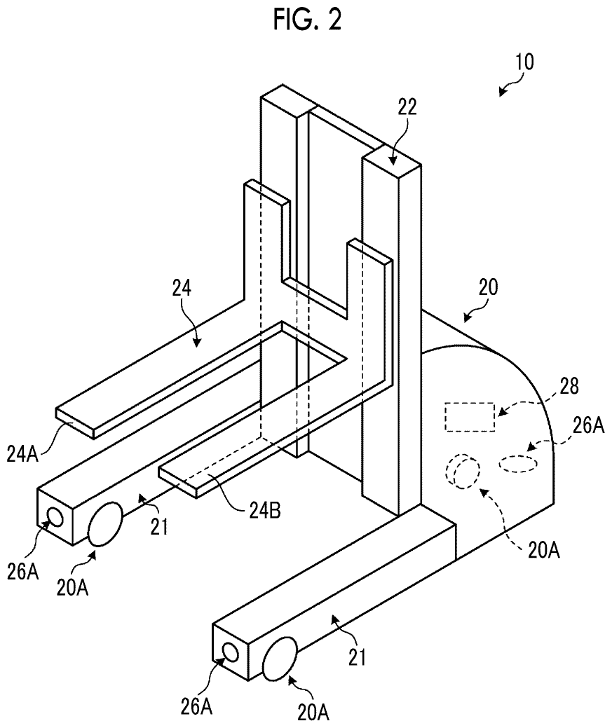

FIG. 2 is a schematic diagram of a configuration of the moving body. The moving body 10 is a device that can automatically move. In the present embodiment, the moving body 10 is a non-holonomic system that cannot move abeam. In the present embodiment, the moving body 10 is a device capable of transporting the target object. Additionally, in the present embodiment, the moving body 10 is a forklift, and more specifically, is a so-called automated guided vehicle (AGV) or an automated guided forklift (AGF). However, the moving body 10 is not limited to a forklift that transports the target object, and may be any device that can automatically move.

As shown in FIG. 2, the moving body 10 includes a vehicle body 20, wheels 20A, straddle legs 21, a mast 22, a fork 24, a sensor 26A, and a control device 28. The straddle legs 21 are a pair of shaft-shaped members provided at one end portion of the vehicle body 20 in a front-rear direction and protruding from the vehicle body 20. The wheels 20A are provided at a tip of each of the straddle legs 21 and on the vehicle body 20. That is, although a total of three wheels 20A are provided, positions and the number of wheels 20A may be optional. The mast 22 is attached to the straddle leg 21 to be movable and moves in the front-rear direction of the vehicle body 20. The mast 22 extends along an up-down direction (here, the Z direction) orthogonal to the front-rear direction. The fork 24 is attached to the mast 22 to be movable in the Z direction. The fork 24 may be movable in a lateral direction (direction crossing the up-down direction and the front-rear direction) of the vehicle body 20 with respect to the mast 22. The fork 24 has a pair of tabs 24A and 24B. The tabs 24A and 24B extend from the mast 22 toward a front direction of the vehicle body 20. The tab 24A and the tab 24B are disposed away from each other in a lateral direction of the mast 22. Hereinafter, in the front-rear direction, a direction on a side on which the fork 24 is provided in the moving body 10 is referred to as a front direction, and a direction on a side on which the fork 24 is not provided is referred to as a rear direction.

The sensor 26A detects at least one of a position and a posture of an object present around the vehicle body 20. It can also be said that the sensor 26A detects at least one of the position of the object with respect to the moving body 10 and the posture of the object with respect to the moving body 10. In the present embodiment, the sensor 26A is provided at the tip of each straddle leg 21 in the front direction and on a rear direction side of the vehicle body 20. However, a position where the sensor 26A is provided is not limited thereto, and the sensor 26A may be provided at any position, and the number of sensors 26A provided may be optional.

The sensor 26A is, for example, a sensor that emits laser light. The sensor 26A emits laser light while scanning in one direction (here, a lateral direction) and detects the position and a direction of the object from reflected light of the emitted laser light. That is, the sensor 26A can also be said to be so-called two-dimensional (2D) light detection and ranging (LiDAR). However, the sensor 26A is not limited to the above and may be a sensor that detects the object via any method, and, for example, may be a so-called three-dimensional (3D) LiDAR that scans in a plurality of directions, may be a so-called one-dimensional (1D) LiDAR that does not scan, or may be a camera.

The control device 28 controls the movement of the moving body 10. The control device 28 will be described below.

### Management Device

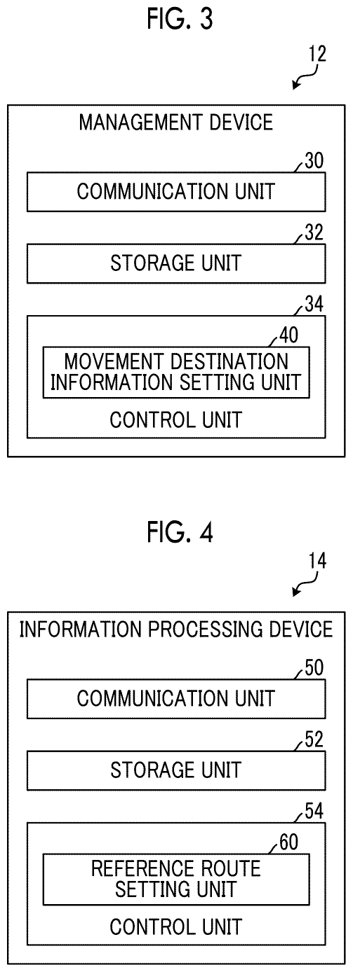

FIG. 3 is a schematic block diagram of the management device. The management device 12 is a system that manages physical distribution in the facility W. Although the management device 12 is a warehouse control system (WCS) or a warehouse management system (WMS) in the present embodiment, the management device 12 is not limited to the WCS and the WMS and may be any system, and may be, for example, a back end system such as other production management systems. A position where the management device 12 is provided is optional, and the management device 12 may be provided in the facility W or may be provided at a location away from the facility W to manage the facility W therefrom. The management device 12 is a computer, and as shown in FIG. 3, includes a communication unit 30, a storage unit 32, and a control unit 34.

The communication unit 30 is a module used for the control unit 34 and communicating with an external device such as the information processing device 14, and may include, for example, an antenna or the like. A communication method via the communication unit 30 is wireless communication in the present embodiment, but the communication method may be optional. The storage unit 32 is a memory that stores various kinds of information, such as computation contents of the control unit 34 and programs, and includes, for example, at least one of a main storage device such as a random-access memory (RAM) or a read-only memory (ROM) and an external storage device such as a hard disk drive (HDD).

The control unit 34 is a computation device, and includes, for example, a computation circuit such as a central processing unit (CPU). The control unit 34 includes a movement destination information setting unit 40. The control unit 34 reads out a program (software) from the storage unit 32 and executes the program to realize the movement destination information setting unit 40, and executes processing thereof. The control unit 34 may execute the processing with one CPU or may include a plurality of the CPUs and may execute the processing with the plurality of CPUs. In addition, the movement destination information setting unit 40 may be realized by a hardware circuit. In addition, a program for the control unit 34 stored in the storage unit 32 may be stored in a recording medium readable by the management device 12.

The movement destination information setting unit 40 sets movement destination information indicating a movement destination of the moving body 10. The setting of the movement destination information will be described later.

The management device 12 may execute processing other than processing of setting the movement destination information. For example, the management device 12 may also set information for controlling a mechanism (for example, an elevator, a door, or the like) other than the moving body 10 provided in the facility W.

### Information Processing Device

FIG. 4 is a schematic block diagram of the information processing device. The information processing device 14 is a device that is provided in the facility W and that processes information regarding the movement of the moving body 10, or the like. The information processing device 14 is, for example, a fleet control system (FCS), but is not limited thereto, and may be any device that processes the information regarding the movement of the moving body 10. The information processing device 14 is a computer, and as shown in FIG. 4, includes a communication unit 50, a storage unit 52, and a control unit 54. The communication unit 50 is a module used for the control unit 54 and communicating with an external device such as the management device 12 or the moving body 10, and may include, for example, an antenna or the like. A communication method via the communication unit 50 is wireless communication in the present embodiment, but the communication method may be optional. The storage unit 52 is a memory that stores various kinds of information, such as computation contents of the control unit 54 and programs, and includes, for example, at least one of a main storage device such as a RAM or a ROM and an external storage device such as an HDD.

The control unit 54 is a computation device, and includes, for example, a computation circuit such as a CPU. The control unit 54 includes a reference route setting unit 60. The control unit 54 reads out a program (software) from the storage unit 52 and executes the program to realize the reference route setting unit 60, and executes processing thereof. The control unit 54 may execute the processing with one CPU or may include a plurality of the CPUs and may execute the processing with the plurality of CPUs. In addition, at least a part of the reference route setting unit 60 may be realized by a hardware circuit. In addition, a program for the control unit 54 stored in the storage unit 52 may be stored in a recording medium readable by the information processing device 14.

The reference route setting unit 60 sets a reference route R0 of the moving body 10. A setting method of the reference route R0 will be described below.

In the present embodiment, the management device 12 and the information processing device 14 are separate devices, but may be integrated into one device. That is, the management device 12 may have at least some functions of the information processing device 14, and the information processing device 14 may have at least some functions of the management device 12.

### Control Device of Moving Body

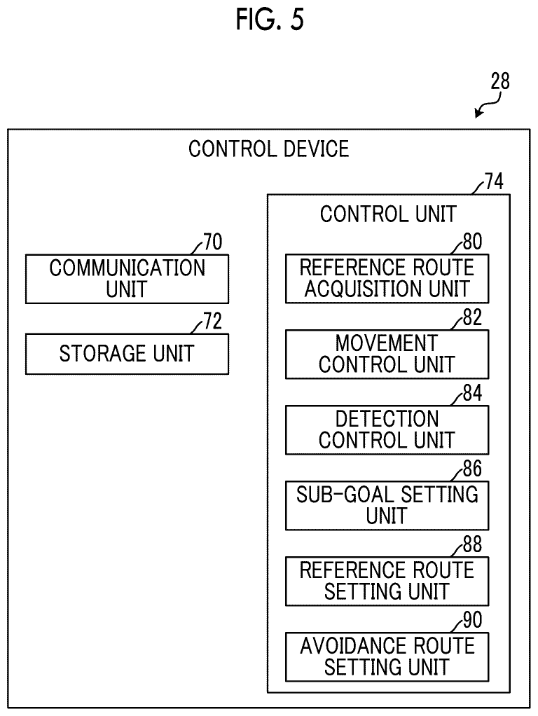

Next, the control device 28 of the moving body 10 will be described. FIG. 5 is a schematic block diagram of the control device of the moving body. The control device 28 is a device that controls the moving body 10. The control device 28 is a computer, and as shown in FIG. 5, includes a communication unit 70, a storage unit 72, and a control unit 74. The communication unit 70 is a module used for the control unit 74 and communicating with an external device such as the information processing device 14, and may include, for example, an antenna or the like. A communication method via the communication unit 70 is wireless communication in the present embodiment, but the communication method may be optional. The storage unit 72 is a memory that stores various kinds of information, such as computation contents of the control unit 74 and programs, and includes, for example, at least one of a main storage device such as a RAM or a ROM and an external storage device such as an HDD.

The control unit 74 is a computation device, and includes, for example, a computation circuit such as a CPU. The control unit 74 includes a reference route acquisition unit 80, a movement control unit 82, a detection control unit 84, a sub-goal setting unit 86, a reference route setting unit 88, and an avoidance route setting unit 90. The control unit 74 reads out a program (software) from the storage unit 72 and executes the program to realize the reference route acquisition unit 80, the movement control unit 82, the detection control unit 84, the sub-goal setting unit 86, the reference route setting unit 88, and the avoidance route setting unit 90, and executes processing thereof. The control unit 74 may execute the processing with one CPU or may include a plurality of the CPUs and may execute the processing with the plurality of CPUs. In addition, at least some of the reference route acquisition unit 80, the movement control unit 82, the detection control unit 84, the sub-goal setting unit 86, the reference route setting unit 88, and the avoidance route setting unit 90 may be realized by a hardware circuit. In addition, a program for the control unit 74 stored in the storage unit 72 may be stored in a recording medium readable by the control device 28.

The reference route acquisition unit 80 acquires the information of the reference route R0. The movement control unit 82 controls a movement mechanism of the moving body 10, such as a drive unit or steering, to control the movement of the moving body 10. The detection control unit 84 acquires a detection result of an obstacle P via the sensor 26A. The sub-goal setting unit 86 sets a sub-goal S based on the detection result of the obstacle P via the sensor 26A. The reference route setting unit 88 sets a reference route R1 passing through a position within a prescribed distance range with respect to the sub-goal S, based on the sub-goal S. The avoidance route setting unit 90 sets an avoidance route R that does not interfere with the obstacle P, based on the reference route R1 and on the detection result of the obstacle P via the sensor 26A. Specific processing contents thereof will be described later.

### Processing of Movement Control System

Processing contents of the movement control system 1 will be described below.

### Setting of Movement Destination Information

The movement destination information setting unit 40 of the management device 12 sets the movement destination information indicating the movement destination of the moving body 10. In the present embodiment, a waypoint is set in advance for each position (coordinates) in the region AR. The movement destination information setting unit 40 may designate a position (coordinates) of a waypoint corresponding to the movement destination itself as the movement destination information. In addition, an identifier is assigned to each of the waypoints, and the movement destination information setting unit 40 may designate an identifier of the waypoint corresponding to the movement destination as the movement destination information. The movement destination information setting unit 40 may set the movement destination information via any method. For example, the movement destination information setting unit 40 may acquire order information indicating the target object to be transported and a transport source and a transport destination and set the movement destination information based on the order information. The movement destination information setting unit 40 transmits the set movement destination information to the information processing device 14 via the communication unit 30.

### Setting of Reference Route

The reference route setting unit 60 of the information processing device 14 sets the reference route R0 of the moving body 10. In the present embodiment, the reference route setting unit 60 sets the reference route R0 based on the movement destination information. Specifically, the reference route setting unit 60 sets a route passing through each position within a prescribed distance range from each waypoint from a movement source to the movement destination as the reference route R0. A position of the movement source may be optionally set, and, for example, the waypoint closest to a current position of the moving body 10 may be set as the movement source. For example, the reference route setting unit 60 sets the route passing through each position within the prescribed distance range from each waypoint from an initial position to the movement destination as the reference route R0, based on the movement destination information and map information of the facility W. In addition, for example, the reference route setting unit 60 may set the reference route R0 based on information of a vehicle specification of the moving body 10 in addition to the movement destination information and the map information of the facility W. The information of the vehicle specification is, for example, a specification that affects a route along which the moving body 10 can move, such as a size or a minimum turn radius of the moving body 10.

The reference route setting unit 60 transmits information of the set reference route R0 to the moving body 10. For example, the reference route setting unit 60 may transmit position information of each position on a trajectory of the reference route R0 to the moving body 10 as the information of the reference route R0.

### Movement of Moving Body

The reference route acquisition unit 80 of the moving body 10 acquires the information of the reference route R0 set by the information processing device 14. The movement control unit 82 of the moving body 10 moves the moving body 10 along the acquired reference route R0. The movement control unit 82 sequentially ascertains position information of the moving body 10 to move the moving body 10 to pass through the reference route R0. Although an acquisition method of the position information of the moving body 10 is optional, for example, in the present embodiment, a detection body (not shown) is provided in the facility W, and the movement control unit 82 acquires information of a position and the posture of the moving body 10 based on detection of the detection body. Specifically, the moving body 10 emits laser light toward the detection body and receives reflected light of the laser light by the detection body to detect the position and the posture of the moving body 10 in the facility W. An acquisition method of the information of the position and the posture of the moving body 10 is not limited to the method using the detection body, and, for example, a method using simultaneous localization and mapping (SLAM) may be used.

### Obstacle

Here, in a case where the obstacle P is present near the reference route R0 along which the moving body 10 is moving, there is a possibility that the moving body 10 collides with the obstacle P or that the moving body 10 stops to not collide with the obstacle P. Therefore, in the present embodiment, the moving body 10 causes the sensor 26A to detect the obstacle P while moving, and sets the avoidance route R for avoiding the obstacle P in a case where there is a possibility of interference with the obstacle P. Hereinafter, a setting method of the avoidance route R will be described.

### Detection of Obstacle

The detection control unit 84 of the moving body 10 causes the sensor 26A to perform detection while the moving body 10 is moving. In the present embodiment, the detection control unit 84 causes the sensor 26A to detect surroundings every predetermined period while the moving body 10 is moving along the reference route R0. The detection control unit 84 determines whether or not the moving body 10 interferes with the obstacle P detected by the sensor 26A in a case where the moving body 10 continues to move, from a detection result via the sensor 26A. A method of determining whether or not the moving body 10 interferes with the obstacle P may be optional. For example, the detection control unit 84 may specify a position of the obstacle P from the detection result via the sensor 26A and determine that the moving body 10 interferes with the obstacle P in a case where the position of the obstacle P is within a prescribed distance range from the reference route R0.

### Setting of Sub-Goal

In a case where it is determined that the moving body 10 interferes with the obstacle P, the sub-goal setting unit 86 sets the sub-goal S based on the detection result via the sensor 26A. The sub-goal S is a position (coordinates) assumed not to interfere with the obstacle P. The sub-goal setting unit 86 sets a plurality of the sub-goals S having different positions. The sub-goal setting unit 86 may set the sub-goal S with any method based on the detection result via the sensor 26A. For example, the sub-goal setting unit 86 sets a position different from the position of the obstacle P detected by the sensor 26A as the sub-goal S. Hereinafter, a setting example of the sub-goal S will be described.

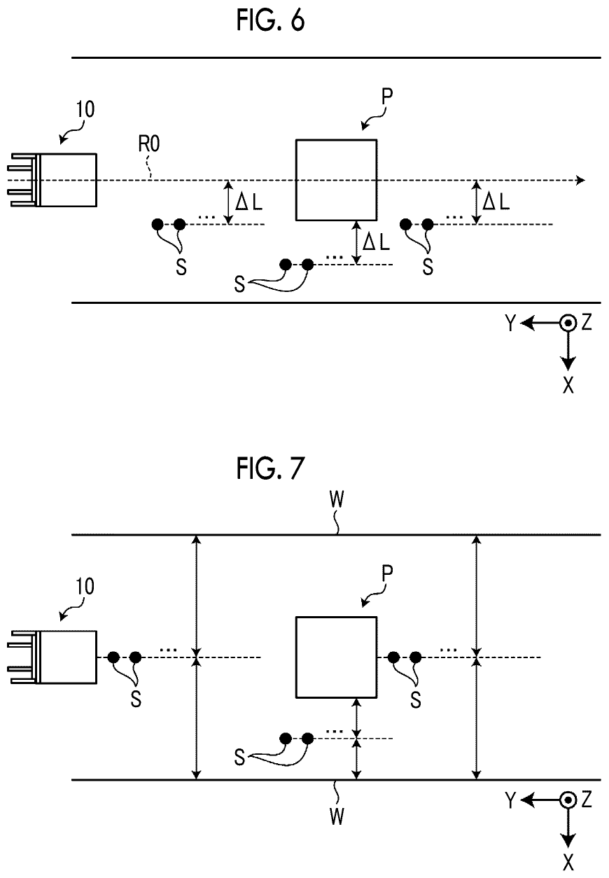

FIGS. 6 to 8 are schematic diagrams showing an example of a setting method of a sub-goal. For example, as shown in FIG. 6, the sub-goal setting unit 86 may set, as the sub-goal S, each position separated from each position on the reference route R0 by a distance AL in a crossing direction (X direction in an example of FIG. 6) crossing a traveling direction (side opposite to the Y direction in the example of FIG. 6) of the reference route R0. Meanwhile, in this case, at positions within a prescribed distance range from the position of the obstacle P detected by the sensor 26A among the positions on the reference route R0, a position separated from the position of the obstacle P detected by the sensor 26A by the distance AL is set as the sub-goal S without setting a position separated from a position on the reference route R0 by the distance AL as the sub-goal S. That is, in the example of FIG. 6, the sub-goal setting unit 86 sets, as the sub-goal S, each position separated from each position on the reference route R0 outside the prescribed distance range from the position of the obstacle P by the distance AL in the crossing direction and a position separated from the position of the obstacle P by the distance AL in the crossing direction. The distance AL may be optionally set and is preferably a constant length for each position, but is not limited thereto and may be a different length for each position.

In addition, for example, as shown in FIG. 7, the sub-goal setting unit 86 may set, as the sub-goal S, a set of positions (preferably, midpoint positions) between obstacles detected by the sensor 26A in the crossing direction (X direction in the example of FIG. 6) crossing the traveling direction (side opposite to the Y direction in the example of FIG. 6) of the reference route R0. In an example of FIG. 7, the obstacle P is detected on a traveling direction side of the reference route R0, and walls W as obstacles are detected on both sides in the crossing direction. In this case, in a section where the obstacle P is not present and the walls W are present on both sides in a section toward the traveling direction side of the reference route R0, the sub-goal setting unit 86 sets each position (each midpoint position in the present example) between the walls W on both sides on a crossing direction side as the sub-goal S. In addition, in a section where the obstacle P is present in the section toward the traveling direction side of the reference route R0, the sub-goal setting unit 86 sets each position (each midpoint position in the present example) between the walls W and the obstacle P in the crossing direction as the sub-goal S.

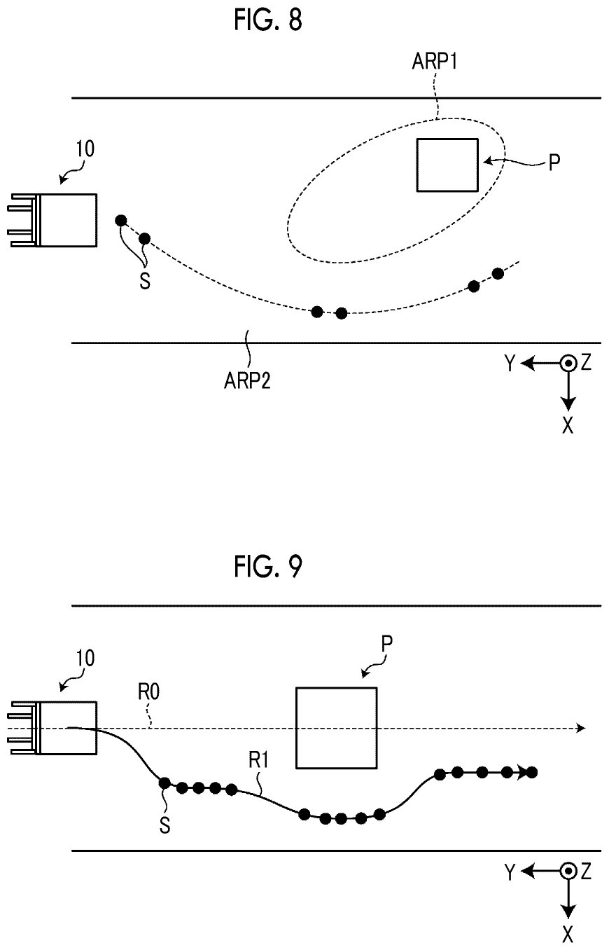

In addition, for example, as shown in FIG. 8, in a case where the sub-goal setting unit 86 determines that the obstacle P moves, the sub-goal setting unit 86 may set an obstacle region ARP1 that may exist as the obstacle P moves. In this case, the sub-goal setting unit 86 may set each position that is a position on an outer side of the obstacle region ARP1 and that is arranged in the traveling direction of the reference route R0, as the sub-goal S. A method of determining that the obstacle P moves may be optional. For example, the sub-goal setting unit 86 may specify a shape of the obstacle P from the detection result of the sensor 26A and determine that the obstacle P moves in a case where the shape satisfies a predetermined condition. In addition, the sub-goal setting unit 86 may treat all the detected obstacles P as obstacles that move without determining whether or not the obstacles P move. The sub-goal setting unit 86 may set the obstacle region ARP1 with any method based on the position of the obstacle P detected by the sensor 26A. For example, the sub-goal setting unit 86 may set a region with each position separated from the position of the obstacle P detected by the sensor 26A by a prescribed distance as an outer circumference, as the obstacle region ARP1.

### Setting of Reference Route

FIG. 9 is a schematic diagram showing an example of setting a reference route. The reference route setting unit 88 sets the reference route R1 based on the sub-goal S set by the sub-goal setting unit 86. The reference route R1 refers to a route used for setting the avoidance route R described below. The reference route setting unit 88 sets a route passing through the position within the prescribed distance range with respect to the sub-goal S as the reference route R1. In the present embodiment, since a plurality of the sub-goals S are set, it can be said that the reference route setting unit 88 sets a route passing through each position within a prescribed distance range with respect to each sub-goal S, as the reference route R1. In an example of FIG. 9, the reference route R1 passes over each sub-goal S, but is not limited to this and may be a route that passes through a position separated from each sub-goal S by a prescribed distance.

The reference route setting unit 88 may set the reference route R1 with any method based on the sub-goal S, but in the present embodiment, the reference route setting unit 88 sets the reference route R1 by using a method that results in a lower computation load than a computation load in the setting of the avoidance route R described later. More specifically, the reference route setting unit 88 sets the reference route R1 based on the sub-goal S and on a motion characteristic of the moving body 10. A motion characteristic here can be said to be a constraint condition based on the motion characteristic of the moving body 10. That is, it can be said that the reference route setting unit 88 sets the route passing through each position within the prescribed distance range with respect to each sub-goal S while satisfying the constraint condition based on the motion characteristic of the moving body 10, as the reference route R1. The motion characteristic of the moving body 10 refers to, for example, the minimum turn radius, an upper limit speed, and the like of the moving body 10.

In the present embodiment, it is preferable that the reference route setting unit 88 sets the reference route R1 without using position information of the obstacle P specified from the detection result of the sensor 26A. That is, it is preferable that the reference route setting unit 88 sets the reference route R1 without using, as a constraint condition, non-interference with the obstacle P specified from the detection result of the sensor 26A. By not applying the non-interference with the obstacle P as the constraint condition, a computation load can be reduced, and the reference route R1 can be calculated in a short computation time.

For example, the reference route setting unit 88 may set the reference route R1 using a pure-pursuit method, a dynamic window approach, or the like.

### Setting of Avoidance Route

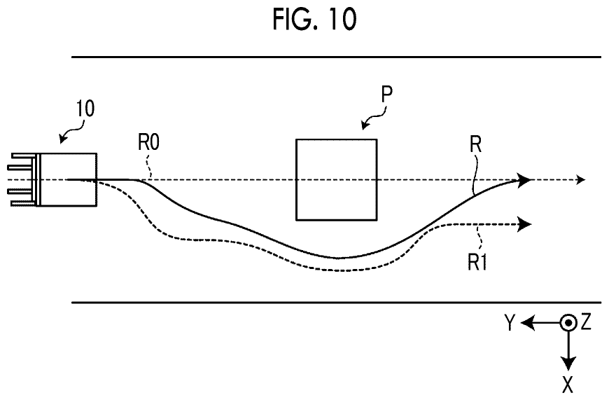

FIG. 10 is a schematic diagram showing an example of setting an avoidance route. The avoidance route setting unit 90 sets the avoidance route R that can avoid the obstacle P, based on the reference route R1 set by the reference route setting unit 88 and on the detection result of the sensor 26A acquired by the detection control unit 84. That is, the avoidance route setting unit 90 sets the avoidance route R that does not interfere with the obstacle P detected by the sensor 26A, based on information of the reference route R1 and on the position information of the obstacle P detected by the sensor 26A. Here, the avoidance route R can be calculated from only the position information of the obstacle P, but in the present embodiment, since the avoidance route R can be calculated with reference to the reference route R1 by using the information of the reference route R1, it is possible to set an appropriate avoidance route R while shortening the computation time.

In the present embodiment, the avoidance route setting unit 90 sets the avoidance route R by performing optimization calculation with the reference route R1 as an initial solution and the constraint condition of no interference with the obstacle P. Furthermore, it is preferable that the avoidance route setting unit 90 sets the avoidance route R by performing optimization calculation with the reference route R1 as the initial solution and satisfying the constraint condition of no interference with the obstacle P and the constraint condition based on the motion characteristic of the moving body 10. That is, the avoidance route setting unit 90 sets the avoidance route R by performing optimization calculation with a constraint condition that the moving body 10 is not positioned within a prescribed distance range from the position of the obstacle P specified from the detection result via the sensor 26A and that the motion characteristic of the moving body 10 is satisfied and using the reference route R1 as the initial solution. Accordingly, it is possible to set the avoidance route R that does not interfere with the obstacle P while satisfying the motion characteristic of the moving body 10, as appropriate while shortening the computation time. The initial solution here is a base solution in the optimization calculation. That is, by searching for an optimum solution from the reference route R1 which is the initial solution, it is possible to converge quickly to the optimum solution, and it is possible to set the appropriate avoidance route R while shortening the computation time.

For example, the avoidance route setting unit 90 may set the avoidance route R by using a primal-dual interior point method, sequential quadratic programming, or the like.

### Movement Along Avoidance Route

In a case where the avoidance route R is generated by the avoidance route setting unit 90, the movement control unit 82 switches from the reference route R0 to the avoidance route R and moves the moving body 10 along the avoidance route R. Accordingly, it is possible to appropriately avoid the obstacle P. In a case where avoidance of the obstacle P is completed by the moving body 10 moving along the avoidance route R, the movement control unit 82 may return the moving body 10 to the reference route R0 and cause the moving body 10 to continue to move along the reference route R0.

### Processing Flow

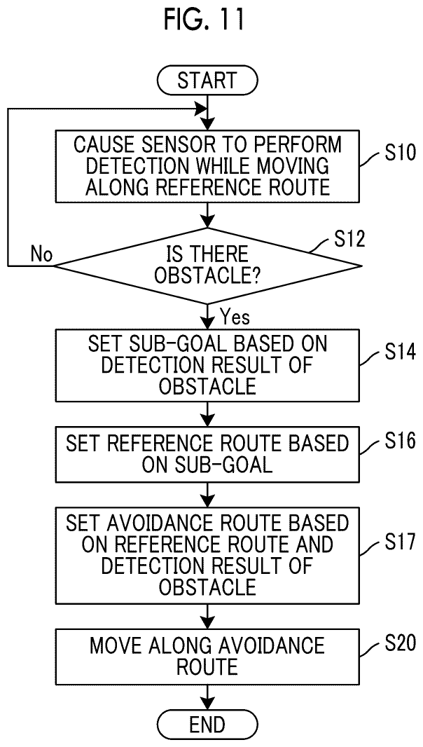

A processing flow for setting the avoidance route R described above will be described. FIG. 11 is a flowchart showing a processing flow for setting the avoidance route. As shown in FIG. 11, while the moving body 10 moves along the reference route R0, the moving body 10 causes the sensor 26A to detect the surroundings via the detection control unit 84 (step S10). The detection control unit 84 acquires the detection result of the sensor 26A and determines whether or not there is an obstacle P that interferes with the moving body 10 (step S12). In a case where there is no obstacle P that interferes with the moving body 10 (step S12; No), the processing returns to step S10 and the moving body 10 continues to move along the reference route R0. On the other hand, in a case where there is an obstacle P that interferes with the moving body 10 (step S12; Yes), the moving body 10 sets the sub-goal S based on the detection result of the obstacle P via the sensor 26A, via the sub-goal setting unit 86 (step S14), sets the reference route R1 based on the set sub-goal S, via the reference route setting unit 88 (step S16), and sets the avoidance route R based on the reference route R1 and on the detection result of the obstacle P via the sensor 26A, via the avoidance route setting unit 90 (step S17). The moving body 10 for which the avoidance route R is set switches to the avoidance route R and moves along the avoidance route R (step S20).

As described above, in the present embodiment, in a case where the obstacle P is detected, the sub-goal S is set based on the detection result of the obstacle P, and the reference route R1 passing through the sub-goal S is set. The avoidance route R is set from the reference route R1 and the detection result of the obstacle P. Here, the setting of the avoidance route that can avoid the obstacle P may take a long time until the setting is completed because a computation load is high. Meanwhile, in the present embodiment, the reference route R1 passing through the sub-goal S is set, and the avoidance route R is calculated with reference to the reference route R1. That is, by using the reference route R1 as an initial solution close to the optimum solution that may avoid the obstacle, time required for calculating the avoidance route R can be shortened, and a route that can appropriately avoid the obstacle P can be set while reducing the computation time.

In the present embodiment, the moving body 10 sets the sub-goal, the reference route R1, and the avoidance route R via the sub-goal setting unit 86, the reference route setting unit 88, and the avoidance route setting unit 90, respectively. However, a setting subject of the sub-goal, the reference route R1, and the avoidance route R is not limited to the moving body 10 and may be any subject. For example, the information processing device 14 may include the sub-goal setting unit 86 to set the sub-goal. In addition, for example, the information processing device 14 may include the reference route setting unit 88 to set the reference route R1. In addition, for example, the information processing device 14 may include the avoidance route setting unit 90 to set the avoidance route R.

### Second Embodiment

Next, a second embodiment will be described. The second embodiment differs from the first embodiment in that the sub-goal S or the avoidance route R is set by setting a region AR1 surrounded by point groups M, which are the detection results of the sensor 26A, as a non-interference region. In the second embodiment, description of parts with a configuration common to the first embodiment will not be repeated.

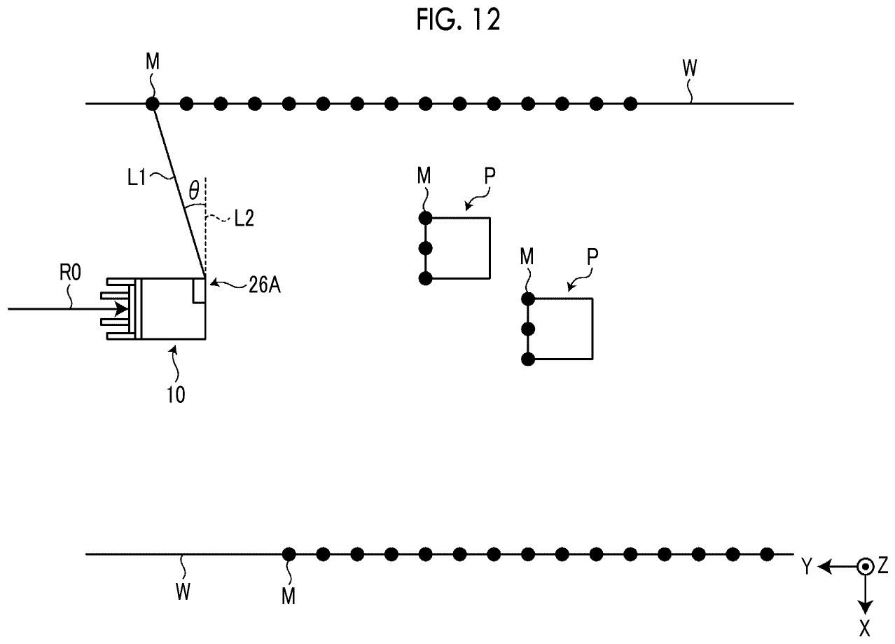

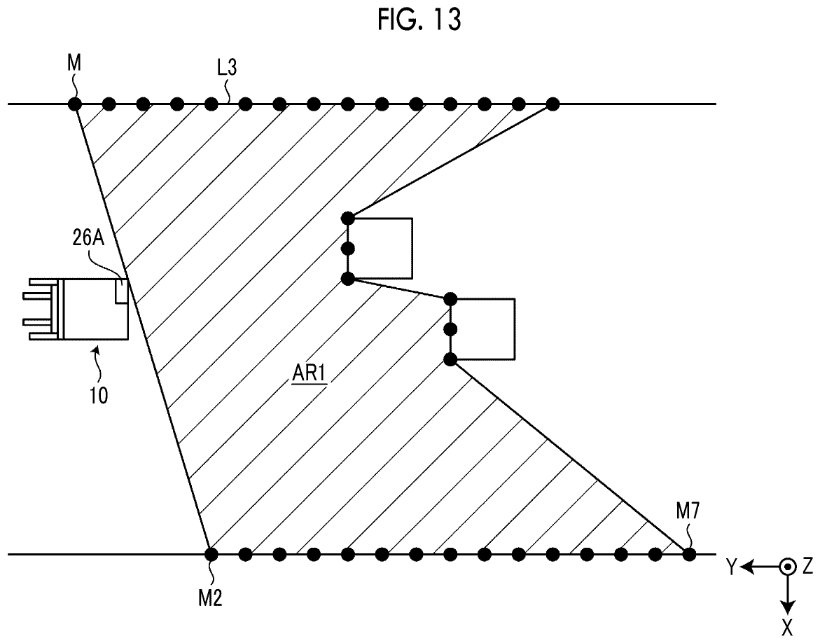

FIGS. 12 and 13 are schematic diagrams for showing setting of the non-interference region. In the second embodiment, the detection control unit 84 causes the sensor 26A to emit laser light. The detection control unit 84 acquires the point groups M based on a detection result of reflected light received by the sensor 26A. That is, the point groups M can be said to be measurement points indicating a position where the laser light is applied (positions where the laser light is reflected). In the present embodiment, the sensor 26A receives reflected light from different positions around the moving body 10 because the sensor 26A emits laser light while scanning in the lateral direction (horizontal direction orthogonal to the Z direction). Therefore, it can be said that the detection control unit 84 acquires a plurality of the point groups M indicating the obstacles around the moving body 10 in one scanning with the laser light. That is, as shown in FIG. 12, a line connecting a position of the sensor 26A to the point group M is referred to as a line L1, a virtual line passing through the sensor 26A and having a fixed direction with respect to the moving body 10 is referred to as a line L2, and a deviation amount of an angle of the line L1 with respect to the line L2 is referred to as an azimuth angle θ between the sensor 26A and the point group M. In this case, it can be said that the detection control unit 84 acquires the plurality of point groups M having different values of the azimuth angle θ. In an example of FIG. 12, two obstacles P are present on the traveling direction side of the reference route R0 with respect to the moving body 10, and the walls W are present on both sides of the reference route R0 in the traveling direction. Therefore, in the example of FIG. 12, the detection control unit 84 acquires point groups M indicating positions of the walls W on both sides and point groups M indicating the positions of the obstacles P.

As shown in FIG. 13, the detection control unit 84 calculates a line L3 connecting each point group M in an order of a magnitude of the azimuth angle θ from the position of the sensor 26A. That is, the line L3 includes a line connecting a point group M1 at which the azimuth angle θ is smallest from the position of the sensor 26A (in an example of FIG. 13, the azimuth angle θ is most negative), a line connecting each point group M in ascending order of the azimuth angle θ, and a line connecting the position of the sensor 26A to a point group M2 at which the azimuth angle θ is largest (in the example of FIG. 13, the azimuth angle θ is most positive). The detection control unit 84 sets an inside of the region AR1 surrounded by the line L3 calculated in this way as the non-interference region.

In the second embodiment, at least one of the sub-goal S and the avoidance route R is set based on the non-interference region set in this way. For example, in a case where the sub-goal S is set based on the non-interference region, the sub-goal setting unit 86 sets the sub-goal S to be positioned in the non-interference region. In this case, the sub-goal setting unit 86 may set each position that is in the non-interference region and that is arranged in a traveling direction of the moving body 10, as the sub-goal S. In addition, for example, in a case where the avoidance route R is set based on the non-interference region, the avoidance route setting unit 90 sets the avoidance route R such that the moving body 10 is positioned in the non-interference region (not positioned outside the non-interference region). That is, the avoidance route R may be set by treating a fact that the moving body 10 is positioned in the non-interference region as the constraint condition of no interference with the obstacle P and performing optimization calculation with the reference route R1 as the initial solution and satisfying a constraint condition that the moving body 10 is positioned in the non-interference region and the constraint condition based on the motion characteristic of the moving body 10.

By setting the non-interference region in this way and setting the sub-goal S or the avoidance route R, for example, computation such as ray tracing is not required, and computation time of the sub-goal S or of the avoidance route R can be shortened. In addition, for example, even in a case where there are a plurality of the obstacles P, a non-interference region that does not interfere with the obstacles P can be set. Therefore, a route that can avoid the plurality of obstacles P can be set as appropriate.

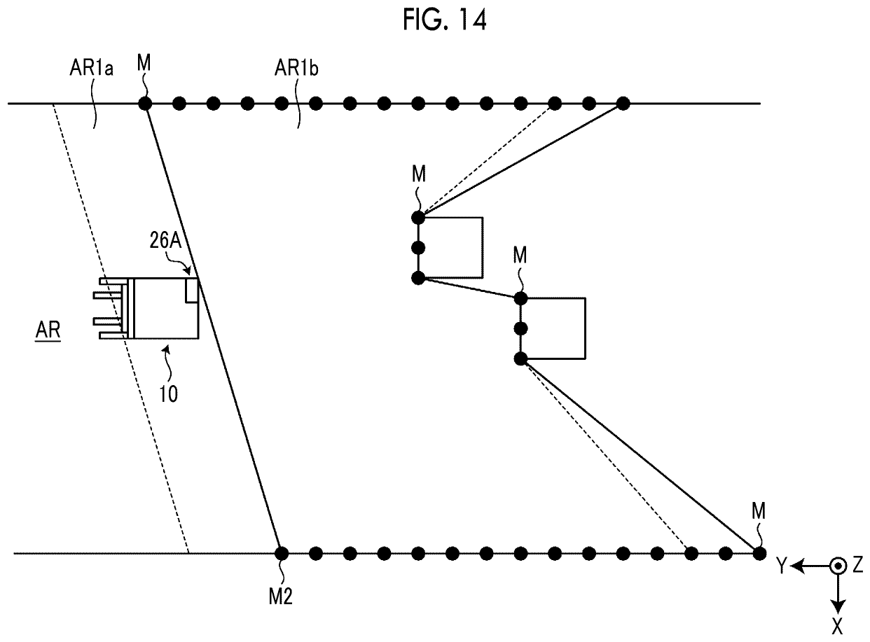

FIG. 14 is a schematic diagram for showing another example of the setting of the non-interference region. In the present embodiment, since the sensor 26A is caused to perform the detection every predetermined period, the detection control unit 84 acquires a set of the point groups M acquired by one scanning for each detection of the sensor 26A (for each position of the moving body 10). In this case, for each of a plurality of sets of the point groups M acquired for each detection, the detection control unit 84 sets the region AR1 surrounded by the line L3 with the above-described method, based on one set of the point groups M. For example, in an example of FIG. 14, a region AR1 a set from point groups M acquired by detection at a certain time and a region AR1b set from point groups M acquired by detection at another time are shown. The detection control unit 84 may set the non-interference region based on each of the set regions AR1. A setting method of the non-interference region based on each of the regions AR1 may be optional. For example, the detection control unit 84 divides an entire region (region AR) into a plurality of unit regions, and counts the number of times each unit region is positioned in the region AR1 for each region AR1. The detection control unit 84 may set a group of unit regions in which the number of times the unit region is positioned in the region ARI is equal to or larger than a predetermined threshold value, as the non-interference region.

As described above, by setting the non-interference region based on the region AR1 for each detection of the sensor 26A, it is possible to set the non-interference region from the accumulated detection results, and it is possible to set the non-interference region that is assumed not to interfere with the obstacle P with higher accuracy.

### Third Embodiment

Next, a third embodiment will be described. The third embodiment differs from the first embodiment in that some point groups M, which are the detection results of the sensor 26A, are reduced, and remaining point groups M are used as analysis point groups to set the sub-goal S or the avoidance route R. In the third embodiment, description of parts with a configuration common to the first embodiment will not be repeated. The third embodiment can also be applied to the second embodiment.

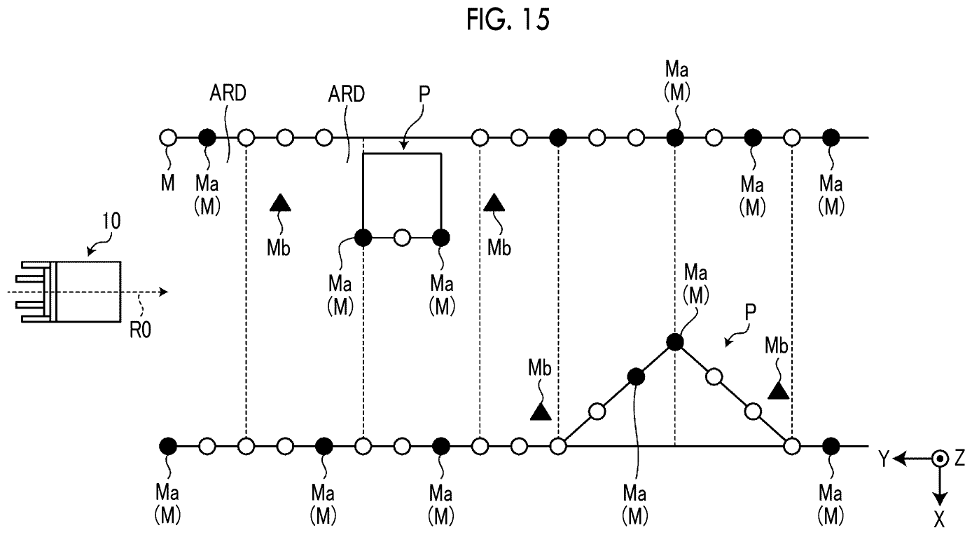

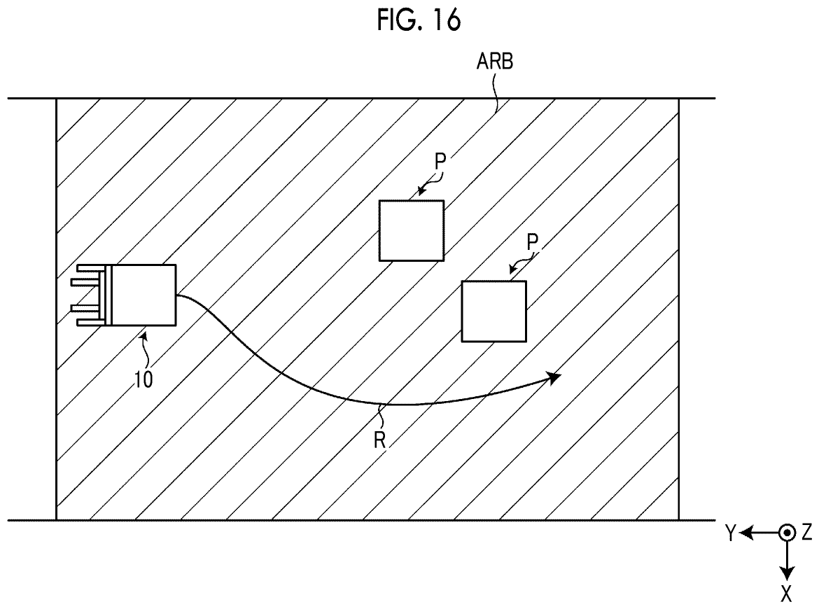

FIG. 15 is a schematic diagram showing an example of an extraction method of the analysis point groups. In the third embodiment, the detection control unit 84 extracts the analysis point groups from the acquired point groups M based on a distance from the moving body 10 to the point groups M. It is preferable that the detection control unit 84 extracts point groups M close to the moving body 10 (reference route R0) as the analysis point groups. Specifically, as shown in FIG. 15, the detection control unit 84 divides the region AR in which the moving body 10 is assumed to move into a plurality of regions to set division regions ARD. The division regions ARD may be optionally set. For example, as shown in FIG. 15, the detection control unit 84 may set a plurality of the division regions ARD by dividing a region on the traveling direction side of the reference route R0 from the position of the moving body 10 at each prescribed distance in the traveling direction of the reference route R0. The detection control unit 84 extracts, as nearby point groups Ma, point groups M closest to the moving body 10 (reference route R0) among the point groups M in the division regions ARD. The detection control unit 84 performs this processing for each division region ARD to extract the nearby point groups Ma for each division region ARD. In an example of FIG. 15, for each of the division regions ARD, the detection control unit 84 extracts a point group M closest to the moving body 10 (reference route R0) among a plurality of the point groups M positioned on one side in the crossing direction (X direction in the example of FIG. 15) with respect to the moving body 10 (reference route R0) and a point group M closest to the moving body 10 (reference route R0) among a plurality of the point groups M positioned on the other side in the crossing direction with respect to the moving body 10 (reference route R0), as the nearby point groups Ma of the division region ARD.

The detection control unit 84 sets the extracted nearby point groups Ma as the analysis point groups. In the third embodiment, at least one of the sub-goal S and the avoidance route R is set based on the analysis point groups set in this way. That is, in the present embodiment, point groups M other than the point groups M extracted as the analysis point groups are not used for computation of at least one of the sub-goal S and the avoidance route R. For example, based on the analysis point groups, the position of the obstacle P may be specified and the sub-goal S or the avoidance route R may be set as in the first embodiment. In addition, for example, based on the analysis point groups, the non-interference region may be set and the sub-goal S or the avoidance route R may be set as in the second embodiment. Some point groups M acquired in this way are extracted as the analysis point groups and used for the sub-goal S or the avoidance route R, so that it is possible to reduce a dimensionality in computation and to reduce the computation time.

Furthermore, the detection control unit 84 may extract positions (for example, center positions) between adjacent nearby point groups Ma as auxiliary point groups Mb, and may set the nearby point groups Ma and the auxiliary point groups Mb as the analysis point groups. In this case, for example, the detection control unit 84 may calculate a distance between the adjacent nearby point groups Ma and set the auxiliary point groups Mb between the adjacent nearby point groups Ma in a case where the distance is equal to or greater than a predetermined threshold value. As described above, by setting the auxiliary point groups Mb at positions where the nearby point groups Ma are separated from each other, it is possible to suppress a decrease in computation accuracy while reducing the computation time.

### Fourth Embodiment

Next, a fourth embodiment will be described. The fourth embodiment differs from the first embodiment in that the avoidance route R is set to pass through an occupied region set for the moving body 10. In the fourth embodiment, description of parts with a configuration common to the first embodiment will not be repeated. The fourth embodiment can also be applied to the second embodiment and the third embodiment.

FIG. 16 is a schematic diagram showing setting of the occupied region. In the fourth embodiment, in a case where the obstacle P is detected by the sensor 26A, in other words, in a case where it is determined that the detected obstacle P interferes with the moving body 10, an occupied region ARB is set. The occupied region ARB is a region in which an approach of the moving body 10 is permitted, but an approach of another moving body is prohibited. In the present embodiment, in a case where the obstacle P is detected, the moving body 10 transmits obstacle information indicating that the obstacle P is detected to the information processing device 14 while setting the sub-goal S, the reference route R1, and the avoidance route R. In a case where the information processing device 14 receives the obstacle information, the information processing device 14 sets the occupied region ARB for the moving body 10. A setting method of the occupied region ARB may be any method, and the information processing device 14 may acquire the current position of the moving body 10 and set the occupied region ARB based on the current position of the moving body 10. For example, the information processing device 14 may set a region having a predetermined size including the current position of the moving body 10 as the occupied region ARB. In addition, for example, the information processing device 14 may acquire information of a current position of the other moving body and set a region including the current position of the moving body 10 and not including the current position of the other moving body as the occupied region ARB. In this case, it is preferable that the information processing device 14 outputs information indicating that the other moving body is to be stopped at the current position to the other moving body to stop the other moving body. In addition, for example, the information processing device 14 may sequentially acquire the current position of the moving body 10 and set, each time the information processing device 14 acquires the current position of the moving body 10, a region including the current position of the moving body 10 as the occupied region ARB. Accordingly, it is possible to dynamically set the occupied region ARB in accordance with the movement of the moving body 10.

In a case where the information processing device 14 sets the occupied region ARB, the information processing device 14 transmits information indicating a position of the occupied region ARB to the moving body 10. The avoidance route setting unit 90 of the moving body 10 sets the avoidance route R such that the moving body 10 is positioned in the occupied region ARB (not positioned outside the occupied region ARB). That is, the avoidance route setting unit 90 may set the avoidance route R by performing optimization calculation with the reference route R1 as the initial solution and satisfying a constraint condition that the moving body 10 is positioned in the occupied region ARB, a constraint condition that the moving body 10 does not interfere with the obstacle P, and the constraint condition based on the motion characteristic of the moving body 10.

The moving body 10 may set the sub-goal S, the reference route R1, and the avoidance route R before acquiring information of the occupied region ARB. Accordingly, since the avoidance route R can be set without waiting for setting of the occupied region ARB, it is not necessary to start computation of the avoidance route R after the information of the occupied region ARB is acquired, and it is possible to immediately switch to the avoidance route R after the information of the occupied region ARB is acquired. In this case, in a case where the avoidance route R has been set at time at which the information of the occupied region ARB is acquired, it is preferable to check whether the set avoidance route R passes through the occupied region ARB. In a case where the set avoidance route R passes through the occupied region ARB, the moving body 10 adopts the avoidance route R and moves along the avoidance route R. On the other hand, in a case where the set avoidance route R does not pass through the occupied region ARB, the moving body 10 may reset the avoidance route R to pass through the occupied region ARB.

Meanwhile, the moving body 10 is not limited to setting the sub-goal S, the reference route R1, and the avoidance route R before acquiring information of the occupied region ARB. The moving body 10 may start the setting of the avoidance route R by using the acquisition of the information of the occupied region ARB as a trigger, may start setting of the reference route R1 by using acquisition of information of the occupied region ARB as a trigger, and may start setting of the sub-goal S by using the acquisition of the information of the occupied region ARB as a trigger. In this case, since the avoidance route R can be set from the beginning by using the constraint condition that the moving body 10 is positioned in the occupied region ARB, the avoidance route R can be set as appropriate.

### Effects of Present Disclosure

As described above, a route-setting method of a first aspect of the present disclosure includes: a step of acquiring a detection result of an obstacle P detected by a sensor 26A provided in a moving body 10, a step of setting a sub-goal S, which is a position assumed not to interfere with the obstacle P, based on the detection result of the obstacle P, a step of setting a reference route R1 passing through a position within a prescribed distance range with respect to the sub-goal S, and a step of setting an avoidance route R for the moving body 10 that does not interfere with the obstacle P, based on the reference route R1 and on the detection result of the obstacle P. According to the present disclosure, the avoidance route R is calculated with reference to the reference route R1, so that the appropriate avoidance route R can be set while shortening the computation time.

A route-setting method of a second aspect of the present disclosure is the route-setting method of the first aspect, in which in the step of setting the avoidance route R, the avoidance route R is set by performing optimization calculation with the reference route R1 as an initial solution and a constraint condition of no interference with the obstacle P. According to the present disclosure, by using the reference route R1 as the initial solution close to the optimum solution that may avoid the obstacle P, the time required for calculating the avoidance route R can be shortened, and the route that can appropriately avoid the obstacle P can be set while reducing the computation time.

A route-setting method of a third aspect of the present disclosure is the route-setting method of the first aspect or the second aspect, in which in the step of setting the reference route R1, the reference route R1 is set based on a motion characteristic of the moving body 10. By setting the reference route R1 based on the motion characteristic, accuracy of the avoidance route R as a reference route is high, and it is possible to more appropriately set the route that can appropriately avoid the obstacle P while reducing the computation time.

A route-setting method of a fourth aspect of the present disclosure is the route-setting method of any one of the first aspect to the third aspect, in which in the step of acquiring the detection result of the obstacle P, a detection result of the sensor 26A is acquired as point groups M, a line L3 connecting the point groups M in an order of a magnitude of an azimuth angle θ between a position of the sensor 26A and the point groups M is calculated from the position of the sensor 26A, and an inside of a region AR1 surrounded by the line L3 is set as a non-interference region that does not interfere with the obstacle P, and at least one of the sub-goal S and the avoidance route R is set based on the non-interference region. By setting the non-interference region in this way and setting the sub-goal S or the avoidance route R, for example, computation such as ray tracing is not required, and computation time of the sub-goal S or of the avoidance route R can be shortened. In addition, for example, even in a case where there are a plurality of the obstacles P, a non-interference region that does not interfere with the obstacles P can be set. Therefore, a route that can avoid the plurality of obstacles P can be set as appropriate.

A route-setting method of a fifth aspect of the present disclosure is the route-setting method of the fourth aspect, in which the region AR1 is set each time the sensor 26A is caused to perform detection, and the non-interference region is set based on the region AR1 for each detection of the sensor 26A. According to the present disclosure, it is possible to set the non-interference region from the accumulated detection results, and it is possible to set the non-interference region that is assumed not to interfere with the obstacle P with higher accuracy.

A route-setting method of a sixth aspect of the present disclosure is the route-setting method of any one of the first aspect to the fifth aspect, in which in the step of acquiring the detection result of the obstacle P, a detection result of the sensor 26A is acquired as point groups M, and analysis point groups are extracted from the acquired point groups M based on a distance from the moving body 10 to the point groups M, and at least one of the sub-goal S and the avoidance route R is set based on the analysis point groups. As described above, some acquired point groups M are extracted as the analysis point groups and used for the sub-goal S or the avoidance route R, so that it is possible to reduce the dimensionality in the computation and to reduce the computation time.

A route-setting method of a seventh aspect of the present disclosure is the route-setting method of the sixth aspect, in which a region AR in which the moving body 10 is assumed to move is divided into a plurality of regions along a traveling direction of the moving body 10 to set division regions ARD, and nearby point groups Ma, which are point groups closest to the moving body 10 among the point groups M in the division regions ARD, are extracted as the analysis point groups for each of the division regions ARD. By extracting the analysis point groups in this way, the sub-goal S or the avoidance route R can be set with high accuracy while reducing the computation time.

A route-setting method of an eighth aspect of the present disclosure is the route-setting method of the seventh aspect, in which positions between the nearby point groups Ma are also extracted as the analysis point groups. By extracting the analysis point groups in this way, the sub-goal S or the avoidance route R can be set with high accuracy while reducing the computation time.

A route-setting method of a ninth aspect of the present disclosure is the route-setting method of any one of the first aspect to the eighth aspect, further including: a step of setting an occupied region ARB in which a movement of another moving body is not permitted while a movement of the moving body 10 is permitted in a case where the obstacle P is detected by the sensor 26A, in which in the step of setting the avoidance route R, the avoidance route R is set to pass through the occupied region ARB. By setting the avoidance route R to pass through the occupied region ARB in this way, interference between the moving body 10 passing through the avoidance route R and the other moving body can be suppressed.

A program of a tenth aspect of the present disclosure causes a computer to execute: a step of acquiring a detection result of an obstacle P detected by a sensor 26A provided in a moving body 10, a step of setting a sub-goal S, which is a position assumed not to interfere with the obstacle P, based on the detection result of the obstacle P, a step of setting a reference route R1 passing through a position within a prescribed distance range with respect to the sub-goal S, and a step of setting an avoidance route R for the moving body 10 that does not interfere with the obstacle P, based on the reference route R1 and on the detection result of the obstacle P. According to the present disclosure, the avoidance route R is calculated with reference to the reference route R1, so that the appropriate avoidance route R can be set while shortening the computation time.

A moving body 10 of an eleventh aspect of the present disclosure moves along an avoidance route R set not to interfere with an obstacle P. The avoidance route R is set based on a reference route R1 passing through a position within a prescribed distance range with respect to a sub-goal S and on a detection result of the obstacle P detected by a sensor 26A provided in the moving body 10, and the sub-goal S is set as a position assumed not to interfere with the obstacle P based on the detection result of the obstacle P. According to the present disclosure, it is possible to move along the appropriate avoidance route R calculated in a short computation time.

Although the embodiments of the present disclosure have been described above, the embodiments are not limited by the contents of the embodiments. In addition, the above-described components include those that can be easily assumed by those skilled in the art, those that are substantially the same, and those that are within a so-called equivalent range. Further, the above-described components can be combined as appropriate. Furthermore, various omissions, replacements, or modifications of the above-described components can be made without departing from the concept of the above-described embodiments.

### REFERENCE SIGNS LIST

10: moving body
12: management device
14: information processing device
26A: sensor
84: detection control unit
86: sub-goal setting unit
88: reference route setting unit
90: avoidance route setting unit
P: obstacle
R: avoidance route
R1: reference route
S: sub-goal

1. A route-setting method comprising:
a step of setting a first reference route to a movement destination;
a step of acquiring a detection result of an obstacle detected by a sensor provided in a moving body, while the moving body is moving along the first reference route;
a step of setting a sub-goal, which is a position assumed not to interfere with the obstacle, based on the detection result of the obstacle;
a step of setting a second reference route passing through a position within a prescribed distance range with respect to the sub-goal; and
a step of setting an avoidance route for the moving body that does not interfere with the obstacle, based on the second reference route and on the detection result of the obstacle.

2. The route-setting method according to claim 1,
wherein in the step of setting the avoidance route, the avoidance route is set by performing optimization calculation with the second reference route as an initial solution and a constraint condition of no interference with the obstacle.

3. The route-setting method according to claim 1,
wherein in the step of setting the second reference route, the second reference route is set based on a motion characteristic of the moving body.

4. The route-setting method according to claim 1,
wherein in the step of acquiring the detection result of the obstacle, a detection result of the sensor is acquired as point groups,
a line connecting the point groups in an order of a magnitude of an azimuth angle between a position of the sensor and the point groups is calculated from the position of the sensor, and an inside of a region surrounded by the line is set as a non-interference region that does not interfere with the obstacle, and
at least one of the sub-goal and the avoidance route is set based on the non-interference region.

5. The route-setting method according to claim 4,
wherein the region is set each time the sensor is caused to perform detection, and the non-interference region is set based on the region for each detection of the sensor.

6. The route-setting method according to claim 1,
wherein in the step of acquiring the detection result of the obstacle, a detection result of the sensor is acquired as point groups, and
analysis point groups are extracted from the acquired point groups based on a distance from the moving body to the point groups, and at least one of the sub-goal and the avoidance route is set based on the analysis point groups.

7. The route-setting method according to claim 6,
wherein a region in which the moving body is assumed to move is divided into a plurality of regions along a traveling direction of the moving body to set division regions, and
nearby point groups, which are point groups closest to the moving body among the point groups in the division regions, are extracted as the analysis point groups for each of the division regions.

8. The route-setting method according to claim 7,
wherein positions between the nearby point groups are also extracted as the analysis point groups.

9. The route-setting method according to claim 1, further comprising:
a step of setting an occupied region in which a movement of another moving body is not permitted while a movement of the moving body is permitted in a case where the obstacle is detected by the sensor,
wherein in the step of setting the avoidance route, the avoidance route is set to pass through the occupied region.

10. A computer-readable recording medium having stored thereon a program causing a computer to execute:
a step of setting a first reference route to a movement destination;
a step of acquiring a detection result of an obstacle detected by a sensor provided in a moving body while the moving body is moving along the first reference route;
a step of setting a sub-goal, which is a position assumed not to interfere with the obstacle, based on the detection result of the obstacle;
a step of setting a second reference route passing through a position within a prescribed distance range with respect to the sub-goal; and
a step of setting an avoidance route for the moving body that does not interfere with the obstacle, based on the second reference route and on the detection result of the obstacle.

11. A moving body that moves along a first reference route to a movement destination comprises:
a sensor that detects an obstacle;
a detection control unit that causes the sensor to detect the obstacle; and
a movement control unit that switches, when it is determined that the moving body interferes with the obstacle, from the first reference route to an avoidance route, and causes the moving body to move along the avoidance route,
wherein the avoidance route is set based on a second reference route passing through a position within a prescribed distance range with respect to a sub-goal and on a detection result of the obstacle detected by a sensor provided in the moving body, and
the sub-goal is set as a position assumed not to interfere with the obstacle based on the detection result of the obstacle.

12. The route-setting method of claim 1, further comprising:
a step of determining whether the obstacle moves or not; and
a step of setting an obstacle region that may exist as the obstacle moves, in a case where it is determined that the obstacle moves,
wherein in the step of setting the sub-goal, each position that is a position on an outer side of the obstacle region and that is arranged in a traveling direction of the first reference route is set as the sub-goal.
